(19) United States
(12) Patent Application Publication
(10) Pub. No.: US 2006/0249702 A1
(43) Pub. Date: Nov. 9, 2006

(54) Isolation valve for energetic and high temperature gases

(76) Inventors: Matthew M. Besen, Andover, MA (US); Donald K. Smith, Belmont, MA (US); Ron W. Collins JR., Londonderry, NH (US); Jaroslaw Pisera, Bedford, MA (US)

Correspondence Address: PROSKAUER ROSE LLP, ONE INTERNATIONAL PLACE 14TH FL, BOSTON, MA, 02110, US

(21) Appl. No.: 11/124,704

(22) Filed: May 9, 2005

(51) Int. Cl. F16K 5/10

(52) U.S. Cl. 251/208

(57) ABSTRACT

An improved fluid flow control valve that allows for conduction of a substantial portion of thermal energy therethrough includes a first portion, a second portion, and a moveable element The first portion includes an aperture for fluid communication with a fluid source. The second portion includes a second aperture, which is at least partially aligned with the first aperture. The moveable element, which is disposed between and spaced from the first and second portions to allow conduction of at least a substantial portion of thermal energy from the first portion to the second portion. The moveable element includes an aperture that at least partially aligns with the first and second apertures when the moveable element is in an open position and that misaligns with at least one of the first and second apertures when the moveable element is in a closed position.

### FIELD OF THE INVENTION

The invention generally relates to valves, and more particularly to valves used to isolate one or more process chambers from other portions of a substrate processing system.

### BACKGROUND

In general, fabrication of integrated circuits and other semiconductor products include the deposition of one or more layers on a substrate, such as a silicon wafer. Using well-known deposition techniques such as, for example, chemical vapor deposition (CVD), the layers forming the integrated circuit or other structure are grown on the substrate. Specifically, in CVD processes, heated precursor materials react to form the layers on an exposed surface of the substrate.

CVD systems typically include a process chamber in thermal contact with a heating system, a system to control input of precursor materials into the process chamber, and a vacuum system to maintain and to control atmospheric conditions within the process chamber. Some CVD systems also include reactive gas plasma generators, which provide heated or energetic fluids to the process chamber for a number of different types of processing procedures (e.g., chamber cleaning, nitridation of the substrate and/or deposited films, and oxidation of the substrate and/or deposited films).

To control processing, one or more valves can be positioned between the process chamber and the reactive gas plasma generator and/or between the process chamber and the vacuum system. These valves are used to isolate the process chamber from other portions of the CVD system so that a user can control conditions within the process chamber and thus, control more precisely deposition of layers on a substrate. These valves are exposed to fluids (e.g., gaseous species, such as gases including charged particles, uncharged particles, heated gases, unheated gases, reactive gases, unreactive gases, energetic gases, deposition species, and etchant species) within the processing system. It is known that these processing fluids, due to their reactive nature and/or temperature can over time (e.g., several minutes to several hours) degrade or destroy exposed polymeric seals within commercially available valves. As a result, frequent valve replacement, which causes significant time in which the CVD system is unusable, is required to maintain adequate processing control.

### SUMMARY OF THE INVENTION

In general, the present invention features a fluid flow control valve that limits conductance through the valve without the use of a polymeric seal positioned between apertures. The fluid flow control valve includes a first portion defining a first aperture for fluid communication with a fluid source, a second portion defining a second aperture at least partially aligned with the first aperture, and a moveable element disposed between and spaced from the first and second portions. The moveable element defining an aperture that at least partially aligns with the first and second apertures when the moveable element is in an open position an that misaligns with at least one of the first and second apertures when the moveable element is in a closed position. The moveable element is spaced from the first and second portions to limit fluid conductance through the valve when in the closed position without requiring a first seal between the moveable element and the first portion or a second seal between the moveable element and the second portion.

In another aspect, the invention features a fluid flow control valve that protects moving parts from the flow of energetic or heated fluids. The fluid flow control valve includes a first portion defining a first aperture for fluid communication with a fluid source, a second portion defining a second aperture at least partially aligned with the first aperture, and a moveable element disposed between and spaced from the first and second portions. The moveable element defining an aperture that at least partially aligns with the first and second apertures when then moveable element is in an open position and that misaligns with at least one of the first and second apertures when the moveable element is in a closed position. The first and second portions at least substantially shielding the moveable element from the flow of a fluid when the moveable portion is in the open position.

In yet another aspect, the invention features an improved fluid flow control valve that allows for conduction of a substantial portion of thermal energy therethrough. The fluid flow control valve includes a first portion defining a first aperture for fluid communication with a fluid source, a second portion defining a second aperture at least partially aligned with the first aperture, and a moveable element disposed between and spaced from the first and second portions to allow conduction of at least a substantial portion of thermal energy from the first portion to the second portion. The moveable element defines an aperture that at least partially aligns with the first and second apertures when the moveable element is in an open position and that misaligns with at least one of the first and second apertures when the moveable element is in a closed position.

Embodiments of any of the above aspects of the invention can include one or more of the following features. The first portion and the second portion can substantially shield the moveable element from a flow of a fluid when the moveable element is in an open position. The first portion, the second portion, and the moveable element can define concentric cylinders having a common axis, wherein the moveable element is rotatable about the common axis relative to the first and second portions. The moveable element can include a feedthrough portion for imparting a movement to the moveable element to reposition the aperture and wherein at least one of the first and second portions define a feedthrough orifice through which the feedthrough portion of the moveable element extends. In some embodiments, a polymeric seal can be in physical communication with the feedthrough portion of the moveable element. In certain embodiments, the feedthrough portion of the moveable element is rotatable about a longitudinal axis of the valve for rotationally moving the moveable element between the open and the closed positions.

Embodiments of any of the above aspects of the invention can further include any of the following features. The first portion and the moveable portion can be spaced apart to define a gap having a substantially uniform thickness. In some embodiments, the thickness of the gap is in a range of about 0.001 inch to about 0.1 inch (e.g., 0.005 inch, 0.05 inch). The second portion and the moveable portion can also be spaced apart to define a gap (i.e., a second gap) having a substantially uniform thickness. The thickness of the second gap is also within the range of about 0.001 inch to about 0.1 inch. In some embodiments, a fluid supplied to the first aperture of the valve from a fluid source comprises fluorine. In certain embodiments, fluid supplied to the first aperture can comprise a heated or an energetic gas. The heat from the flow of the heated or energetic fluid when the moveable element is in an open position is transferred to the moveable element primarily via a surface proximate to the aperture and in contact with a flow of the heated or energetic fluid through the aperture. In certain embodiments, heat from a heat source is transferred to the moveable element through at least one of the first portion and the second portion. The heat source can be in contact with at least one of the first portion and the second portion and, in some embodiments, can be at least partially embedded within of the first portion or the second portion. The first portion, the second portion, and/or the moveable element can include aluminum. In some embodiments, the valve can further include multiple outlet ports for delivering fluids.

In general, the valves described above can include one or more of the following advantages. The valves can be used in environments where highly energetic gases (e.g., plasma activated fluorine gas) and/or high temperatures (e.g., above 200° C.) are present. The valves described above, due to the positioning of the first portion, the second portion, and the moveable element, can limit conductance therethrough, conduct thermal energy across, and protect movable portions from energetic gases. As a result, a user can control the atmospheric conditions within the process chamber and thus can control the deposition of one or more layers on the substrate when high temperatures and/or energetic gases are utilized. As a further result, the valves experience less wear and tear during usage. Thus, less time is spent reconditioning, maintaining, and/or replacing valves.

In general, another aspect of the invention features an apparatus for delivering dissociated gas. The apparatus includes a generator for dissociating gas and a gas-flow control valve in gaseous communication with a gas output of the generator. The gas-flow control valve includes a first portion defining a first aperture for fluid communication with gas output, a second portion defining a second aperture in fluid communication with a gas delivery port, and a moveable element disposed between and spaced from the first and second portions to allow conductance of at least a substantial portion of thermal energy from the first portion to the second portion. The moveable element defining an aperture that at least partially aligns with the first and second apertures when the moveable element is in an open position and that misaligns with at least one of the first and second apertures when the moveable element is in a closed position.

In another aspect, the invention features an apparatus for delivering dissociated gas. The apparatus includes a generator for dissociating gas and a gas-flow control valve in gaseous communication with a gas output of the generator. The gas-flow control valve includes a first portion defining a first aperture for fluid communication with gas output, a second portion defining a second aperture in fluid communication with a gas delivery port, and a moveable element disposed between and spaced from the first and second portions. The moveable element defining an aperture that at least partially aligns with the first and second apertures when the moveable element is in an open position and that misaligns with at least one of the first and second apertures when the moveable element is in a closed position. The first and second portions at least substantially shielding the moveable element from a flow of a fluid when the moveable portion is in the open position.

In another aspect, the invention features an apparatus for delivering dissociated gas. The apparatus includes a generator for dissociating gas and a gas-flow control valve in gaseous communication with a gas output of the generator. The gas-flow control valve includes a first portion defining a first aperture for fluid communication with gas output, a second portion defining a second aperture in fluid communication with a gas delivery port, and a moveable element disposed between and spaced from the first and second portions. The moveable element defining an aperture that at least partially aligns with the first and second apertures when the moveable element is in an open position and that misaligns with at least one of the first and second apertures when the moveable element is in a closed position. The moveable element is spaced from the first and second portions to limit conductance through the valve when in the closed position without requiring a first seal between the moveable element and the first portion or a second seal between the moveable element and the second portion.

Embodiments of these aspects of the invention can include one or more of the following features. The valve and the generator can be separated by a distance of six inches or less. That is, the valve can be positioned within 6 inches (e.g., 3 inches, 2 inches, 1 inch) from an outlet of a plasma generator because, unlike conventional valves, the valve of the present invention does not include a polymeric seal, which is exposed to the energetic gases and/or high temperatures emitted by the generator. The generator can include a plasma chamber, a transformer having a magnetic core surrounding a portion of the plasma chamber and a primary winding, and an AC power supply inducing an AC potential inside the chamber that forms a toroidal plasma which completes a secondary circuit of the transformer.

In general, the apparatus described above can include one or more of the following advantages. The valve used within the apparatus can prevent backflow of fluids, such as, for example, gases within the process chamber, into the generator when the moveable element is in the closed position. In embodiments, a small amount of a purge gas, such as argon, can be introduced into the gas delivery port of the valve of the apparatus. It is believed that due to the spacing between the first portion, moveable element, and the second portion, the purge gas forms a barrier preventing gases (e.g., gases within the process chamber) from backstreaming through the valve and into the generator when the moveable element is in the closed position. As a result, a user can control the valve to provide isolation between the process chamber and the generator when desired. Another advantage of the present invention is the range of temperatures and gases available for use therein. Specifically, the valve used in the present invention can withstand higher temperatures and can be exposed to more reactive and/or energetic gases than commercially available valves. As a result, higher temperatures can be used during processing. In addition, the valve of the apparatus can be used for a longer period of processing time before requiring maintenance.

In another aspect, the invention features a system including a chamber including an inlet and an outlet for a fluid, a pump for controlling pressure in the chamber, and a valve positioned between the outlet and the pump. The valve includes a first portion, a second portion, and a moveable element. The first portion defines a first aperture for fluid communication with the pump. The second portion defines a second aperture at least partially aligned with the first aperture. The second aperture is in fluid communication with the chamber. The moveable element is disposed between and spaced from the first and second portions to allow conduction of at least a substantial portion of thermal energy from the first portion to the second portion. The moveable element defines an aperture that at least partially aligns with the first and second apertures when the moveable element is in a closed position.

In another aspect, the invention features a system including a chamber including an inlet and an outlet for a fluid, a pump for controlling pressure in the chamber, and a valve positioned between the outlet and the pump. The valve includes a first portion, a second portion, and a moveable element disposed between and spaced from the first and second portions. The first portion defines a first aperture for fluid communication with the gas output. The second portion defines a second aperture at least partially aligned with the first aperture. The second aperture is in fluid communication with a gas delivery port. The moveable element defines an aperture that at least partially aligns with the first and second apertures when the moveable element is in an open position and that misaligns with at least one of the first and second apertures when the moveable element is in a closed position. The moveable element is spaced from the first and second portions to limit conductance through the valve when in the closed position without requiring a first seal between the moveable element and the first portion or a second seal between the moveable element and the second portion.

In another aspect, the invention features a system including a chamber including an inlet and an outlet for a fluid, a pump for controlling pressure in the chamber, and a valve positioned between the outlet and the pump. The valve includes a first portion, a second portion, and a moveable element disposed between and spaced from the first and second portions. The first portion defines a first aperture for fluid communication with the gas output. The second portion defines a second aperture at least partially aligned with the first aperture. The second aperture is in fluid communication with a gas delivery port. The moveable element defines an aperture that at least partially aligns with the first and second apertures when the moveable element is in an open position and that misaligns with at least one of the first and second apertures when the moveable element is in a closed position. The first and second portions at least substantially shielding the moveable element from a flow of a fluid when the moveable portions is in the open position.

In general, the systems described above can include one or more of the following features. The valve can operate at a temperature of about 200° C. or more. For example, the valve can operate when exposed to a fluid, such as a heated or an energetic gas which is at a temperature of 200° C., 300° C., 400° C., 500° C., 600° C., 700° C., 800° C., 900° C., or 1000° C. The system described above can be in contact with a heat source. Heat from the heat source can be transferred to the moveable element through at least one of the first portion and the second portion of the valve. In some embodiments, the heat source is in thermal contact with at least one of the first portion and the second portion of the valve. In certain embodiments, the heat source is partially embedded within the first portion or the second portion.

Embodiments of any of the above can include one or more of the following advantages. The valve within the system can be used to regulate pressure within the chamber. Specifically, the conductance of the valve can be varied by rotating the moveable element. As a result of the variable conductance, the pressure within the chamber can be regulated by the combination of the amount of conductance, as determined by the position of the moveable element, and the attached vacuum system. Another advantage of the present invention is that the valve, due to the spacing of the first portion, second portion and moveable element, can be used in systems that include high temperatures (e.g., 200° C., 1000° C.) and/or highly energetic gases (e.g., reactive fluorine gas) without damaging the valve's ability to control flow therethrough.

### DESCRIPTION OF THE FIGURES

In the drawings, like reference characters generally refer to the same parts throughout the different views. Also, the drawings are not necessarily to scale, emphasis instead being placed upon illustrating the principles of the invention.

FIG. 1 is an illustration of a CVD system including three valves according to embodiments of the invention.

FIG. 2A is an exploded view of a valve in accordance with an embodiment of the invention.

FIG. 2B is a cross-sectional view of the assembled valve of FIG. 2A.

FIG. 2C is an illustration of the valve in use with a portion of the CVD system of FIG. 1.

FIG. 2D is an enlarged view of a portion of the valve labeled A in FIG. 2B.

FIG. 3 is another cross-sectional view of the assembled valve of FIG. 2A.

FIG. 4 is an illustration of another embodiment of the valve.

FIG. 5 is a cross-sectional view of a valve in accordance with an embodiment of the invention. FIG. 5 illustrates results of a finite element, steady state thermal study of the valve.

FIG. 6 is a cross-sectional view of a valve in accordance with an embodiment of the invention. FIG. 6 illustrates results of a finite element, steady state thermal study of the valve.

FIG. 7 is a cross-sectional view of a valve in accordance with an embodiment of the invention. FIG. 7 illustrates results of a finite element, steady state thermal study of the valve.

FIG. 8 is a graph of gap spacing between a moveable portion and a first portion or between the moveable portion and a second portion versus theoretical flow rates of purge gases used to maintain a 200 mTorr pressure drop across the valve of FIG. 2A disposed in a closed position.

### DESCRIPTION

The present invention provides a valve for fluid flow control. The fluid flow control valve can be included within systems or apparatus used for processing substrates (e.g., CVD systems). Specifically, the valve used in these systems or apparatus can be used for isolation of one or more parts of a system from its remainder. In general, the valve includes a first portion, a second portion, and a moveable portion disposed between and spaced from the first and second portions. In some embodiments, the valve allows a substantial portion (e.g., between about 85% to about 100% of the thermal energy) of thermal energy to conduct therethrough. In certain embodiments, at least one of the first and second portions of the valve protects moving parts from the flow fluids (e.g., heated fluids, energetic fluids) passing through. In some embodiments, the valve limits fluid conductance without the use of polymeric seals positioned between apertures within the first portion, second portion, or the moveable element.

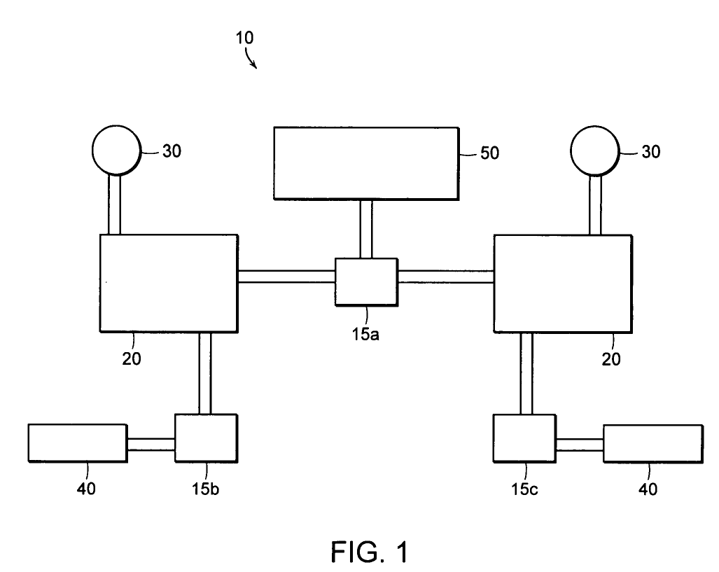

FIG. 1 illustrates a CVD system 10 including three valves 15 (15a, 15b, 15c) in accordance with the present invention. The CVD system 10 is used for processing substrates. Specifically, the CVD system 10 is used to deposit thin films on a substrate from gaseous precursors. The CVD system 10 includes two process chambers 20 that hold the substrates and are in thermal contact with a heating system (not shown), two gas regulatory systems 30 that control the flow of gases into the process chambers 20 (e.g., each regulatory system can include one or more gas tanks in combination with regulators and mass flow controllers), and two vacuum pumps 40. The CVD system 10 also includes a reactive gas plasma generator 50 positioned between the two process chambers 20. The reactive gas plasma generator 50 is used to clean the process chambers 20. That is, the reactive gas plasma generator 50 can be used to deliver reactive, heated, and/or energetic gas, such as, for example, fluorine gas, to the process chambers to remove unwanted deposits, which can form on the walls of the process chambers 20 during deposition. In general, reactive gas plasma generators include a plasma chamber; a transformer having a magnetic core surrounding a portion of the plasma chamber and a primary winding; and an AC power supply inducing an AC potential inside the chamber that forms a toroidal plasma which completes a secondary circuit of the transformer. Examples of commercially available reactive gas plasma generators include the ASTRON® generator, ASTRON® i generator, ASTRON® e generator, and ASTRON® ex generator, all of which are available from MKS, Wilimington, Mass.

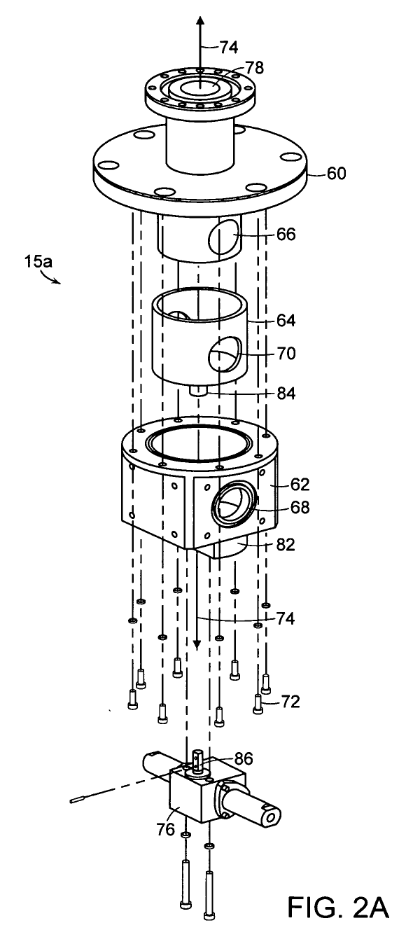

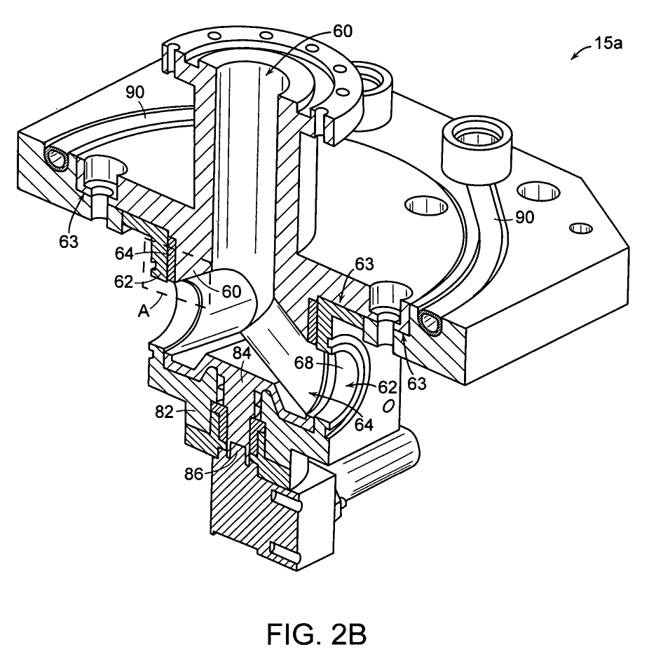

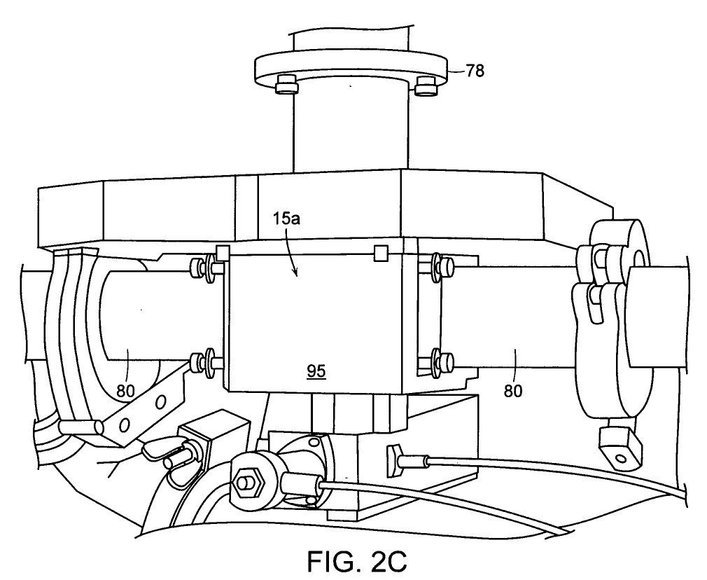

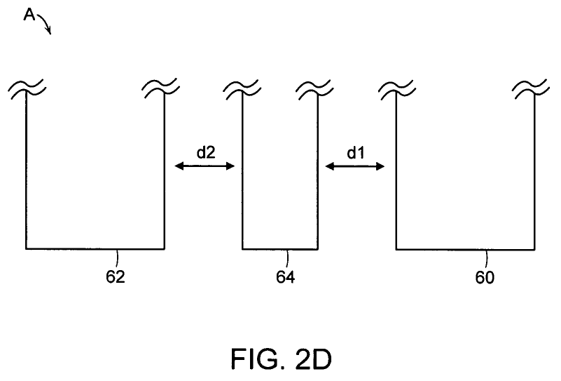

Positioned between the process chambers 20 and the reactive gas plasma generator 50 is one of the three valves, valve 15a. Valve 15a controls the flow of fluids, such as, for example, the flow of reactive, energetic, or heated gases, to the process chambers 20 from the reactive gas plasma generator 50. Referring to FIGS. 2A and 2B, valve 15a includes a first portion 60, a second portion 62, and a moveable element 64 positioned between and spaced from the first and second portions (e.g., see section labeled A in FIG. 2B and FIG. 2D). Each of the first portion 60, second portion 62, and moveable element 64 are made from an unreactive, thermally conductive metal such as, for example, aluminum, and include a pair of apertures 66, 68, and 70, respectively. The first and second portions 60 and 62 of the valve 15a have cylindrically-shaped bodies and are positioned and secured together with fasteners 72 such that apertures 66 and 68 are at least partially aligned and so that there is metal to metal contact (e.g., contact locations 63) between portions 60 and 62 as shown in FIG. 2A. The moveable element 64 also has a cylindrically-shaped body and is rotatable about a longitudinal axis 74 of the valve 15a. As a result, moveable element 64 can be manipulated (e.g., mechanically via feedthrough motor 76) such that apertures 66, 68, and 70 are at least partially aligned. When apertures 66, 68, and 70 are at least partially aligned, fluid entering into input port 78 from the reactive gas plasma generator 50 flows through valve 15a, including apertures 66, 70, and 68. The fluid exits through the pair of apertures 68 in the second portions 62 (see, FIG. 2B) and out of the valve 15a through outlets 80 (see, FIG. 2C) into the process chambers 20.

Valve 15a prevents or limits fluid conductance therethrough when moveable element 64 is in a position in which apertures 70 are misaligned with apertures 66 and 68 (e.g., apertures 66 and 70 are misaligned and/or apertures 68 and 70 are misaligned). As a result, fluid is prevented from flowing from the reactive gas plasma generator 50 through to the outlets 80, thereby isolating the reactive gas plasma generator 50 from the rest of the CVD system 10. When the moveable element 64 in valve 15a is placed in a closed position, that is a position in which apertures 66 and 70 are misaligned and/or apertures 68 and 70 are misaligned, the reactive gas plasma generator 50 is isolated from the rest of the CVD system 10 and fluids from the generator 50 (e.g., reactive gases, energetic gases, heated gases) are prevented from entering the process chambers 20. When the moveable element 64 is positioned in an open position, that is a position in which apertures 66, 70, and 68 are at least partially aligned, fluid from the generator 50 is provided to the process chambers 20.

The moveable element 64 is spaced from the first and second portions 60 and 62 so that the moveable element 64 is free to rotate between the open and closed positions. In certain embodiments, such as the embodiment shown in FIGS. 2A and 2B, a feedthrough motor 76 is provided to control the positioning of the moveable element 64. For example, a CVD operator (e.g., user) can control whether or not fluid flows from the reactive gas plasma generator 50 to the process chambers 20 by activating the feedthrough motor 76. Specifically, the user can position the moveable element 64 in the open position (i.e., fluid flow position) or in the closed position (i.e., fluid flow impeded position) by activating the motor 76 to cause the moveable element 64 to rotate about longitudinal axis 74. To accommodate feedthrough motor 76 and to impart motion to moveable element 64, the second portion 64 includes a feedthrough orifice in its base 82 and the moveable element 64 includes a feedthrough portion 84. The feedthrough portion 84 extends through the feedthrough orifice in base 82 and is connected to a rotating portion 86 of the motor 76. As a result, a user controlling the motion of motor 76 can control the rotation of moveable element 64 and thus, control fluid flow through valve 15a. To prevent or to inhibit leakage from the feedthrough orifice in base 82, a polymeric seal is positioned between the feedthrough orifice and the feedthrough portion 84 (e.g., a polymer o-ring can be positioned about the circumference of the feedthrough portion 84 prior to being inserted into the feedthrough orifice).

In addition to controlling whether or not fluid flows through valve 15a, the user can control the amount of fluid passing through to the outlets 80 by controlling the degree of alignment between the apertures 66, 70, and 68. For example, the user can decrease the fluid flow through the valve 15a by rotating moveable element 64 into a position in which the degree of alignment is diminished (e.g., apertures 66, 68, 70 are only partially aligned so that an open passageway through the valve has an area less than the area defined by aperture 66, 68 or 70). As a result, fluid conductance through the valve 15a decreases and the flow rate drops.

Referring to FIGS. 2B and 2D, the moveable element is spaced from the first and second portions 60, 62 at a distance d1 and d2, respectively. Each of the distances d1 and d2 is large enough to permit the moveable element 64 to rotate, and at the same time, small enough so as to allow thermal conduction between first portion 60 and moveable element 64 and/or between second portion 62 and moveable portion 64. Specifically, due to the spacing of the first portion 60, second portion 62, and moveable element 64, at least 85% (e.g., 90%, 95%, 100%) of thermal energy applied to either the first or second portions is conducted through the valve 15a. That is, a portion (e.g., about 60% to about 80%) of the thermal energy applied to valve 15a is conducted through the metal to metal contact between first and second portions 60, 62 (e.g., at contact locations 63), and the remaining portion (e.g., about 20% to about 40%) of thermal energy applied to valve 15a passes over d1 to moveable portion 64 and then over d2 to second portion 62. In some embodiments, the distance d1 (i.e., the gap between first portion 60 and moveable element 64) is between about 0.0001 inch to about 0.1 inch and has a substantially uniform thickness. In certain embodiments, the distance d1 is between about 0.001 inch to about 0.01 inch, such as for example, 0.005 inch. The distance d2 between second portion 62 and moveable element 64 can also be between about 0.0001 inch and 0.1 inch (e.g., between about 0.001 inch and 0.01 inch) and in some embodiments, d2 has a substantially uniform thicknesses. In certain embodiments, the distance d2 can have the same value as d1.

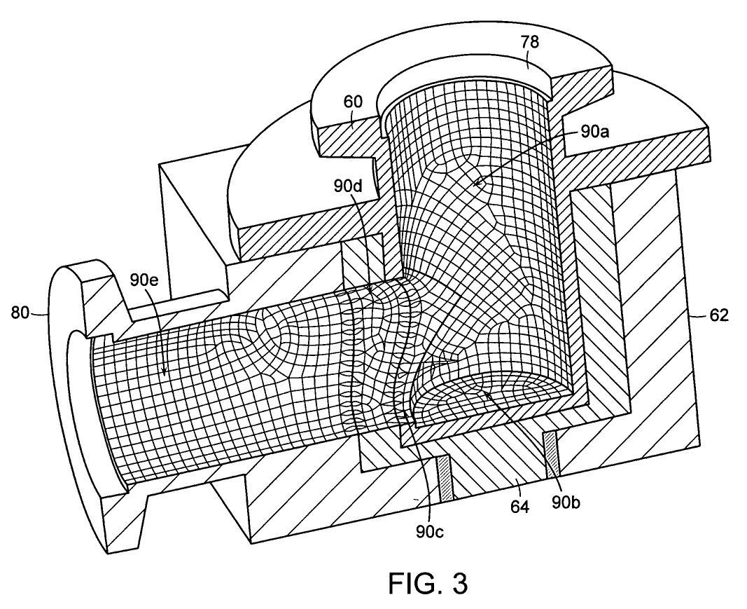

As a result of conducting at least 85% of the thermal energy applied to the first portion 60 or the second portion 62 through the valve, valve 15a experiences less wear and tear at least because the applied thermal energy can be dissipated (conducted) through the valve, and thus overheating of any single portion of valve 15a is prevented and/or limited. Thermal energy (e.g., heat) can be applied to the inside of the valve (e.g., by heated or energetic fluid entering into inlet 78 and contacting the first portion 60) or to the outside of the valve (e.g., by a heat tape wrapped around the exterior of the valve, which is in direct contact with the second portion 62). Heat applied to either the inside of the valve (i.e., first portion 60) or to the exterior of the valve (i.e., the second portion 62) can be transferred to the moveable element 64 via conduction due to the close proximity of the first portion 60 to the moveable element 64 and/or the close proximity of the second portion 62 to the moveable element 64. For example, heat from a flow of a heated or energetic fluid (i.e., a heat source) entering valve 15a through inlet 78 can heat one or more of the five surfaces 90a, 90b, 90c, 90d, and 90e of the first portion 60 and outlet 80 shown in FIG. 3 as the fluid passes through the valve. Due to the thermal connectivity between closely spaced first portion 60, second portion 62, and moveable element 64 heat is transferred to the moveable element 64 (via directly from surface 90d and indirectly across spacing d1) and to the second portion 62 (via from moveable element 64 across d2 and from first portion 60 through the metal to metal contact of the first and second portion 60, 62), thereby limiting overheating of any one portion or element of the valve 15a.

The thermal connectivity between the first portion 60, the second portion 62, and the moveable element 64 can also be used to control the temperature within the valve 15a. In some embodiments, the temperature of the first portion 60 can be reduced by applying a heat sink (e.g., a cooling plate, tube of cooling fluid) to the second portion 62. In certain embodiments, the temperature of the first portion 60 can be increased by applying a heat source (e.g., a heater) to the second portion 62. As a result of the thermal connectivity between portions 60, 62 and the moveable element 64, heat can be carried away from (i.e., when the heat sink is used) or carried to (i.e., when the heat source is used) the first portion 60 through the moveable element 64 and the second portion 62 or through the second portion 62 alone. Thus, the temperature of the first portion 60 can be controlled. For example, in some embodiments, a user can prevent and/or limit overheating of the valve 15a by providing the cooling source to the second portion 62 and in other embodiments, the user can evaporate deposits within the valve 15a by applying the heat source to the second portion 62.

In certain embodiments, the heat source (e.g., heated fluid, heater) or heat sink (e.g., cooling plate, tube of cooling fluid) is at least partially embedded within either first portion 60 and/or second portion 62. For example, as shown in FIG. 2B, a tube of cooling fluid 90 is partially embedded within second portion 62. In other embodiments, the heat source or heat sink can be in physical contact with a surface of either the first portion 60 or the second portion 62. For example, a heated fluid coming from the reactive gas plasma reactor 50 can be provided to the interior surfaces 90a, 90b, 90c, and 90d of first portion 60, or a heat tape can be wrapped about the exterior surfaces 95 of the second portion 62.

When in the closed position, valve 15a limits fluid conductance therethrough without the use of polymeric seals positioned between the first portion 60 and the moveable element 64, and/or the second portion 62 and the moveable element 64. Specifically, fluid flow is at least substantially prevented from flowing from inlet 78 through the valve 15a to outlets 80 due to the spacing of the first and second portions 60, 62 and moveable element 64 (i.e., d1 and d2) when the valve is in the closed position. Thus, unlike conventional valves which rely on polymeric seals between moving parts to create a tight seal and to stop flow, valve 15a does not include a polymeric seal within its flow path (e.g., an open passageway between inlet 79 through to outlets 80). As a result, valve 15a can be used in environments inhospitable to polymeric seals without damaging the valve's ability to close. For example, valve 15a can be used to control the flow of energetic fluorine gas, without having to rely on time consuming valve maintenance to replace warn or destroyed polymeric seals.

Valve 15a is also able to withstand harsh or inhospitable environments due to its configuration. Besides it lack of use of polymeric seals within the fluid flow path, the positioning of the first and second portions 60, 62 serves to protect the moveable element 64 from fluid flow. As a result, only the stationary portions of the valve (i.e., the first portion 60 and the second portion 62) are exposed to the fluid passing through the valve. The moveable element 64 and the rotating portion 86 are not exposed to the flowing fluid and thus are not harmed by fluid interactions. In general, moving parts are more likely to be susceptible to damage from the flow of fluid than stationary parts. Thus, the first and the second portions 60, 62 are positioned to shield the moving parts (e.g., secured portions 60 and 62 surround the moveable element 64 and the rotating portion 86) from the flowing fluid.

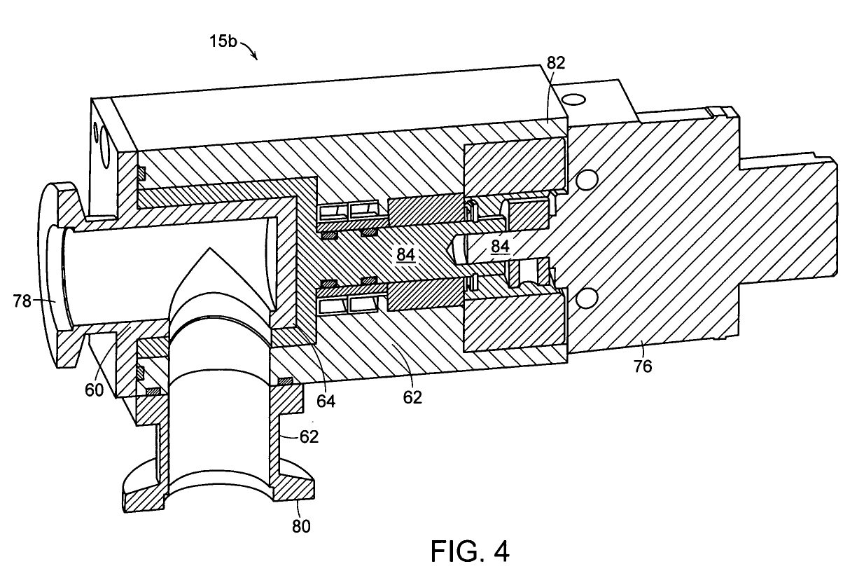

Besides valve 15a, CVD system 10 also includes valves 15b and 15c. Valves 15b and 15c are each positioned between one of the process chambers 20 and one of the vacuum pumps 40. Referring to FIG. 4, valves 15b and 15c each include first portion 60, second portion 62 and moveable element 64. The first and second portions 60 and 62 and the moveable element 64 are spaced as described above for valve 15a. In fact, valves 15b and 15c are identical to valve 15a except for in the number of outlet paths included. Specifically, valve 15a includes two outlet paths (i.e., two apertures in each of the first portion 60, the second portion 62, the moveable element 64 and two outlets 80), whereas each of valves 15b and 15c include only one outlet path (i.e., one aperture in each of the first portion 60, the second portion 62, the moveable element 64 and one outlet 80).

Valves 15b and 15c work in combination with the vacuum pumps 40 to aid in the control of conditions within the process chambers 20. For example, when valves 15b and 15c are in the open position, each of the process chambers 20 are under the influence of their respective vacuum pumps 40 (e.g., under reduced pressure). When the valves 15b and 15c are in the closed position, the process chambers 20 are isolated from their respective vacuum pumps 40 and when the valves 15b and 15c are in between the open and closed positions, the process chambers 20 experience some degree of vacuum influence. As a result, the user can control the pressure within process chambers 20 (e.g., amount of vacuum applied to process chambers 20) by controlling the positioning of the valves 15b and 15c.

In certain embodiments, the flow paths of valves 15b and 15c are exposed to reactive gases, such as, for example fluorine. In some embodiments, the flow paths of valves 15b and 15c are exposed to energetic fluids, such as, for example, plasmas. In some embodiments, the flow paths of valves 15b and 15c are exposed to high temperatures (e.g., in the range of about 200° C. to about 1000° C., in the range of about 300° C. to about 900° C.). In any of the above embodiments, valves 15b and 15c are able to maintain their ability to rotate between the open and closed positions and to provide a user with control over chamber conditions (e.g., chamber isolation).

As a result of valves' 15a, 15b, and 15c ability to continue to provide a user control over chamber conditions even under inhospitable conditions, valves 15a, 15b, and 15c can be positioned near apparatus that radiate heat or generate reactive or energetic fluids. For example, valve 15a can be positioned within a distance of six inches or less (e.g., five inches, four inches, three inches) to the reactive gas generator 50 without causing severe damage to the valve (e.g., valve maintenance or repair within the first three months after installation). Typically, valves of the present invention will require maintenance less frequently than once every six months and in some embodiments, the valves will need to be maintained only once a year (e.g., after 500,000 many rotations of the valve, after 1,000,000 many rotations of the valve).

The examples given below further illustrate some of the advantages of valves 15a, 15b, and 15c.

### EXAMPLE 1

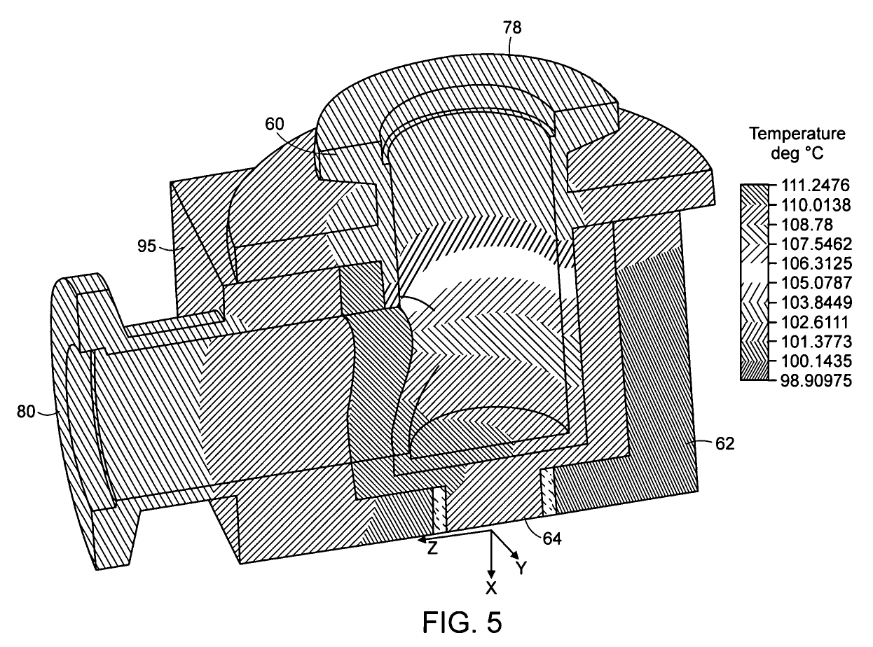

FIG. 5 shows the results of a steady state thermal finite element analysis calculation. In this example, the first portion 60, the second portion 62, and the moveable element 64 were each made from aluminum having a thermal conductivity of 4.24 W/in/° C. The spacing between the first portion 60 and the moveable element 64, d1, was 0.005 inch and the spacing between the second portion 62 and the moveable portion, d2, was also 0.005 inch. The thermal analysis studied the resulting temperature effects for flowing fluorine gas having a thermal conductivity of 7.08×10⁻⁴ W/in/° C. and coming from a reactive gas plasma generator through the valve. It was determined that the fluorine gas applied heat to five surfaces 90a, 90b, 90c, 90d, and 90e of the first portion 60 and outlet 80 (see FIG. 3) as it passed through the valve at an internal heat flux rate of 3 W/in². The ambient temperature used in this calculation was 50° C. and the exterior of the valve experienced cooling at a rate of 0.03 W/in². As shown in FIG. 5, the maximum temperature experienced by the valve was 111.248° C. and the minimum temperature value was 98.9097° C. Thus, the valve having a d1 of 0.005 inch and a d2 of 0.005 inch was able to thermally conduct a substantial portion of the applied thermal energy through the valve as evidenced by the small thermal gradient within the valve (i.e., a gradient of 12.338° C. between the maximum and minimum temperatures throughout the valve).

### EXAMPLE 2

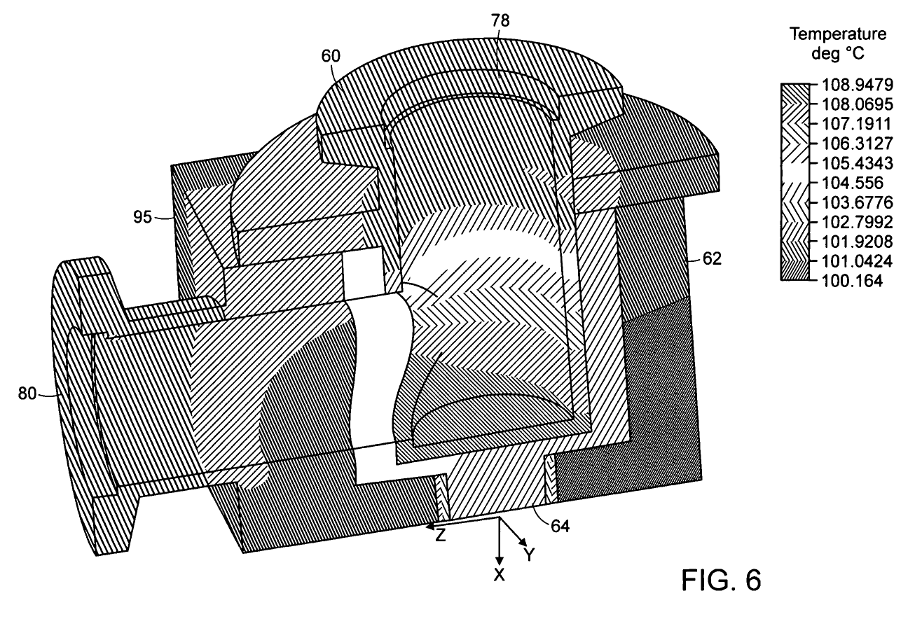

FIG. 6 shows the results of a steady state thermal finite element analysis calculation. In this example, the first portion 60, the second portion 62, and the moveable element were each made from aluminum having a thermal conductivity of 4.24 W/in/° C. The spacing between the first portion 60 and the moveable element 64, d1, was 0.001 inch and the spacing between the second portion 62 and the moveable portion, d2, was also 0.001 inch. The thermal analysis studied the resulting temperature effects for flowing fluorine gas having a thermal conductivity of 7.08×10⁻⁴ W/in/C and coming from a reactive gas plasma generator through the valve. Heat was applied to the five surfaces 90a, 90b, 90c, 90d, and 90e of the first portion 60 and outlet 80 (see FIG. 3) as fluorine gas passed through the valve at an internal heat flux rate of 3 W/in². The ambient temperature used in this calculation was 50° C. and the exterior of the valve experienced cooling at a rate of 0.03 W/in². As shown in FIG. 6, the maximum temperature experienced by the valve was 108.948° C. and the minimum temperature value was 100.164° C.

As a result of decreasing d1 and d2 as compared to Example 1, a decrease in a temperature gradient within the valve was experienced (i.e., 8.784° C. for Example 2 versus 12.338° C. for Example 1). Thus, even more heat was conducted (i.e., lower thermal resistance) through the valve of this Example than in the valve of Example 1. As a result, it is believed that increases in thermal conductivity through the valve are a result of the closer spacing of d1 and d2 of the moveable element 64 to the first and second portions 60 and 62, respectively. For example, as d2 decreases the temperature gradient between moveable element 64 and second portion 62 decreases resulting in more thermal energy being passed from moveable element 64 to second portion 62 and vice versa.

### EXAMPLE 3

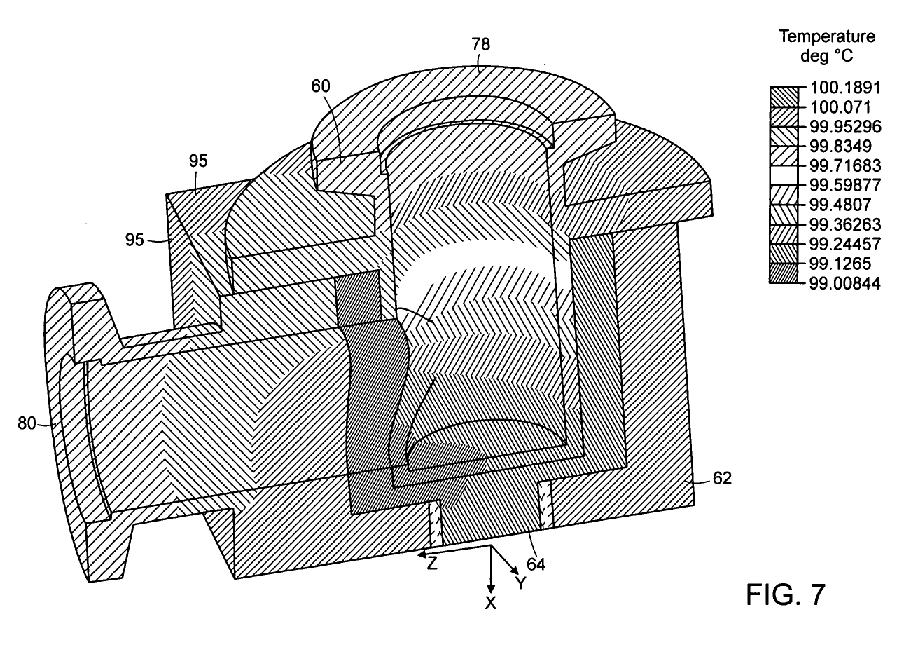

FIG. 7 shows the results of a steady state thermal finite element analysis calculation. In this example, the first portion 60, the second portion 62, and the moveable element were each made from aluminum having a thermal conductivity of 4.24 W/in/C. The spacing between the first portion 60 and the moveable element 64, d1, was 0.005 inch and the spacing between the second portion 62 and the moveable portion, d2, was also 0.005 inch.

The thermal analysis studied the resulting temperature effects for applying an external heater to the second portion 62 of the valve. Specifically, this analysis calculated the effect of wrapping a heat tape having a temperature of 100° C. around the external surfaces of the valve. As shown in FIG. 7, the maximum temperature experienced by the valve was 100.189° C. and the minimum temperature value was 99.0084° C. Thus, a valve having a d1 of 0.005 inch and a d2 of 0.005 inch was able to thermally conduct substantially all of the thermal energy applied to the second portion 62 through to the first portion 60 as evidenced by the small thermal gradient throughout the valve (i.e., 1.181° C.).

Variations, modifications, and other implementations of what is described herein will occur to those of ordinary skill without departing from the spirit and the scope of the invention. Such as, for example, while valves 15a, 15b, and 15c have been described above as having either one or two outlet paths, a valve in accordance with the present invention can have any number (e.g., one, two, three, four) of outlet paths. Accordingly, the invention is not to be defined only by the preceding illustrative description.

### EXAMPLE 4

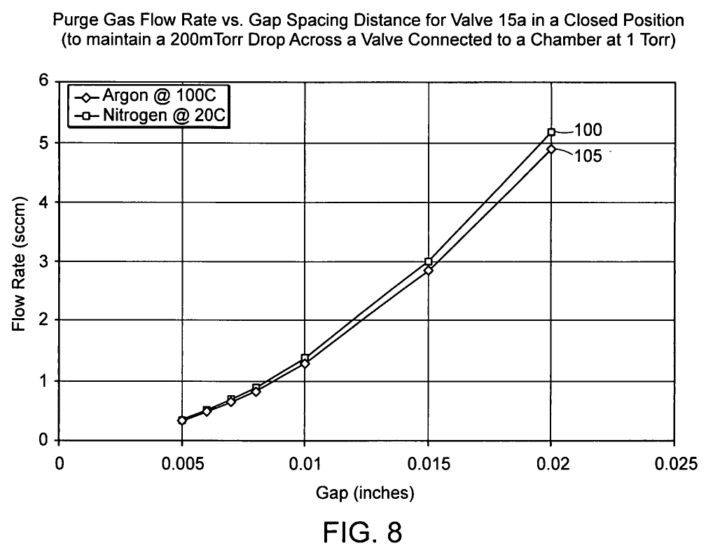

FIG. 8 illustrates the amount of purge and/or flow gas used to create a 200 mTorr pressure drop across a closed valve, thereby preventing flow in an undersirable direction (i.e., preventing flow through the valve 15a from inlet 78 to outlet 80). Purge gas can be introduced below reactor 50 through inlet 78. The graph in FIG. 8 shows the amount of nitrogen gas (at 20° C.) 100 and the amount of argon gas (at 100° C.) 105 used to create a 200 mTorr drop across a valve having a ⅝ inch inner diameter, a geometry as shown in FIG. 2A, and connected to a chamber held at 1 Torr. In addition, this graph further shows the theoretical value of both the nitrogen gas 100 and the argon gas 105 used to maintain the 200 mTorr pressure drop in closed valves having a ⅝ inch inner diameter for various gas spacings/distances (e.g., a gap of 0.005 inches corresponds to a d1 equal to 0.005 inches and a d2 equal to 0.005 inches). As shown by the graph in FIG. 8, a valve having a gap of 0.005 inches uses less than 1 sccm of purge gas (i.e., either nitrogen gas 100 or argon gas 105) to effectively keep the pressure at inlet 78 at a value of 1.2 Torr while the pressure at the output 80 is at 1 Torr.

What is claimed is:

1. A fluid flow control valve, comprising:
a first portion defining a first aperture for fluid communication with a fluid source;
a second portion defining a second aperture at least partially aligned with the first aperture; and
a movable element disposed between and spaced from the first and second portions to allow conduction of at least a substantial portion of thermal energy from the first portion to the second portion, the moveable element defining an aperture that at least partially aligns with the first and second apertures when the moveable element is in an open position and that misaligns with at least one of the first and second apertures when the moveable element is in a closed position.

2. The valve of claim 1, wherein the first portion and the second portion substantially shield the moveable element from a flow of a fluid when the moveable element is in an open position.

3. The valve of claim 1, wherein the first portion, the second portion, and the moveable element define concentric cylinders having a common axis, and the moveable element is rotatable about the common axis relative to the first and second portions.

4. The valve of claim 1, wherein the moveable element further comprises a feedthrough portion for imparting a movement to the moveable element to reposition the aperture, and wherein at least one of the first and second portions define a feedthrough orifice through which the feedthrough portion of the moveable element extends.

5. The valve of claim 4, wherein a polymeric seal in physical communication with the feedthough portion of the moveable element, provides a fluid seal.

6. The valve of claim 4, wherein the feedthrough portion of the moveable element is rotatable about a longitudinal axis of the valve for rotationally moving the moveable element between the open and the closed positions.

7. The valve of claim 1, wherein the first portion and the moveable portion are spaced apart to define a gap having a substantially uniform thickness.

8. The valve of claim 7, wherein the thickness of the gap is in a range of about 0.0001 inch to about 0.1 inch.

9. The valve of claim 1, wherein the second portion and the moveable portion are spaced apart to define a gap having a substantially uniform thickness.

10. The valve of claim 9, wherein the thickness of the gap is in a range of about 0.0001 inch to about 0.1 inch.

11. The valve of claim 1, wherein a fluid, supplied to the first aperture from the fluid source, comprises a heated or energetic gas.

12. The valve of claim 1, wherein a fluid, supplied to the first aperture from the fluid source, comprises fluorine.

13. The valve of claim 1, wherein heat from a flow of a heated or energetic fluid when the moveable element is in an open position is transferred to the moveable element primarily via a surface proximate to the aperture and in contact with a flow of the heated or energetic fluid through the aperture.

14. The valve of claim 1, wherein heat from a heat source is transferred to the moveable element through at least one of the first portion and the second portion.

15. The valve of claim 14, wherein the heat source is in contact with at least one of the first portion and the second portion.

16. The valve of claim 14, wherein the heat source is at least partially embedded within one of the first portion or the second portion.

17. The valve of claim 1, wherein the first portion comprises aluminum.

18. The valve of claim 1, wherein the second portion comprises aluminum.

19. The valve of claim 1, wherein the moveable element comprises aluminum.

20. The valve of claim 1 further comprising multiple outlet ports.

21. A fluid flow control valve comprising:
a first portion defining a first aperture for fluid communication with a fluid source;
a second portion defining a second aperture at least partially aligned with the first aperture; and
a movable element disposed between and spaced from the first and second portions, the moveable element defining an aperture that at least partially aligns with the first and second apertures when the moveable element is in an open position and that misaligns with at least one of the first and second apertures when the moveable element is in a closed position, the first and second portions at least substantially shielding the moveable element from a flow of a fluid when the moveable portion is in the open position.

22. The valve of claim 21, wherein the first portion, the second portion, and the moveable element define concentric cylinders having a common axis, and the moveable element is rotatable about the common axis relative to the first and second portions.

23. The valve of claim 21, wherein the moveable element further comprises a feedthrough portion for imparting a movement to the moveable element to reposition the aperture, and wherein at least one of the first and second portions define a feedthrough orifice through which the feedthrough portion of the moveable element extends.

24. The valve of claim 23, wherein a polymeric seal in physical communication with the feedthough portion of the moveable element, provides a fluid seal.

25. The valve of claim 23, wherein the feedthrough portion of the moveable element is rotatable about a longitudinal axis of the valve for rotationally moving the moveable element between the open and the closed positions.

26. The valve of claim 21, wherein the first portion and the moveable portion are spaced apart to define a gap having a substantially uniform thickness.

27. The valve of claim 26, wherein the thickness of the gap is in a range of about 0.0001 inch to about 0.1 inch.

28. The valve of claim 21, wherein the second portion and the moveable portion are spaced apart to define a gap having a substantially uniform thickness.

29. The valve of claim 28, wherein the thickness of the gap is in a range of about 0.0001 inch to about 0.1 inch.

30. The valve of claim 21, wherein a fluid, supplied to the first aperture from the fluid source, comprises a heated or energetic gas.

31. The valve of claim 21, wherein a fluid, supplied to the first aperture from the fluid source, comprises fluorine.

32. The valve of claim 21, wherein heat from a flow of a heated or energetic fluid when the moveable element is in an open position is transferred to the moveable element primarily via a surface proximate to the aperture and in contact with a flow of the heated or energetic fluid through the aperture.

33. The valve of claim 21, wherein heat from a heat source is transferred to the moveable element through at least one of the first portion and the second portion.

34. The valve of claim 33, wherein the heat source is in contact with at least one of the first portion and the second portion.

35. The valve of claim 33, wherein the heat source is at least partially embedded within one of the first portion or the second portion.

36. The valve of claim 21, wherein the first portion comprises aluminum.

37. The valve of claim 21, wherein the second portion comprises aluminum.

38. The valve of claim 21, wherein the moveable element comprises aluminum.

39. The valve of claim 21 further comprising multiple outlet ports.

40. A fluid flow control valve comprising:
a first portion defining a first aperture for fluid communication with a fluid source;
a second portion defining a second aperture at least partially aligned with the first aperture; and
a movable element disposed between the first and the second portions, the moveable element defining an aperture that at least partially aligns with the first and second apertures when the moveable element is in an open position and that misaligns with at least one of the first and second apertures when the moveable element is in a closed position, the moveable element is spaced from the first and second portions to limit conductance through the valve when in the closed position without requiring a first seal between the moveable element and the first portion or a second seal between the moveable element and the second portion.

41. The valve of claim 40, wherein the first portion and the second portion substantially shield the moveable element from a flow of a fluid when the moveable element is in an open position.

42. The valve of claim 40, wherein the first portion, the second portion, and the moveable element define concentric cylinders having a common axis, and the moveable element is rotatable about the common axis relative to the first and second portions.

43. The valve of claim 40, wherein the moveable element further comprises a feedthrough portion for imparting a movement to the moveable element to reposition the aperture, and wherein at least one of the first and second portions define a feedthrough orifice through which the feedthrough portion of the moveable element extends.

44. The valve of claim 43, wherein a polymeric seal in physical communication with the feedthough portion of the moveable element, provides a fluid seal.

45. The valve of claim 43, wherein the feedthrough portion of the moveable element is rotatable about a longitudinal axis of the valve for rotationally moving the moveable element between the open and the closed positions.

46. The valve of claim 40, wherein the first portion and the moveable portion are spaced apart to define a gap having a substantially uniform thickness.

47. The valve of claim 46, wherein the thickness of the gap is in a range of about 0.0001 inch to about 0.1 inch.

48. The valve of claim 40, wherein the second portion and the moveable portion are spaced apart to define a gap having a substantially uniform thickness.

49. The valve of claim 48, wherein the thickness of the gap is in a range of about 0.0001 inch to about 0.1 inch.

50. The valve of claim 40, wherein a fluid, supplied to the first aperture from the fluid source, comprises a heated or energetic gas.

51. The valve of claim 40, wherein a fluid, supplied to the first aperture from the fluid source, comprises fluorine.

52. The valve of claim 40, wherein heat from a flow of a heated or energetic fluid when the moveable element is in an open position is transferred to the moveable element primarily via a surface proximate to the aperture and in contact with a flow of the heated or energetic fluid through the aperture.

53. The valve of claim 40, wherein heat from a heat source is transferred to the moveable element through at least one of the first portion and the second portion.

54. The valve of claim 53, wherein the heat source is in contact with at least one of the first portion and the second portion.

55. The valve of claim 53, wherein the heat source is at least partially embedded within one of the first portion or the second portion.

56. The valve of claim 40, wherein the first portion comprises aluminum.

57. The valve of claim 40, wherein the second portion comprises aluminum.

58. The valve of claim 40, wherein the moveable element comprises aluminum.

59. The valve of claim 40 further comprising multiple outlet ports.

60. An apparatus for delivering dissociated gas, the apparatus comprising:
a generator for dissociating gas; and
a gas flow-control valve in gaseous communication with a gas output of the generator, the valve comprising:
a first portion defining a first aperture for fluid communication with the gas output;
a second portion defining a second aperture at least partially aligned with the first aperture, the second aperture in fluid communication with a gas delivery port; and
a movable element disposed between and spaced from the first and second portions to allow conduction of at least a substantial portion of thermal energy from the first portion to the second portion, the moveable element defining an aperture that at least partially aligns with the first and second apertures when the moveable element is in an open position and that misaligns with at least one of the first and second apertures when the moveable element is in a closed position.

61. The apparatus of claim 60, wherein a distance between the valve and the generator is less than six inches.

62. The apparatus of claim 60, wherein the generator comprises:
a plasma chamber;
a transformer having a magnetic core surrounding a portion of the plasma chamber and a primary winding; and
an AC power supply inducing an AC potential inside the chamber that forms a toroidal plasma which completes a secondary circuit of the transformer.

63. An apparatus for delivering dissociated gas, the apparatus comprising:
a generator for dissociating gas; and
a gas flow-control valve in gaseous communication with a gas output of the generator, the valve comprising:
a first portion defining a first aperture for fluid communication with the gas output;
a second portion defining a second aperture at least partially aligned with the first aperture, the second aperture in fluid communication with a gas delivery port; and
a movable element disposed between and spaced from the first and second portions, the moveable element defining an aperture that at least partially aligns with the first and second apertures when the moveable element is in an open position and that misaligns with at least one of the first and second apertures when the moveable element is in a closed position, the first and second portions at least substantially shielding the moveable element from a flow of a fluid when the moveable portion is in the open position.

64. The apparatus of claim 63, wherein a distance between the valve and the generator is less than six inches.

65. The apparatus of claim 63, wherein the generator comprises:
a plasma chamber;
a transformer having a magnetic core surrounding a portion of the plasma chamber and a primary winding; and
an AC power supply inducing an AC potential inside the chamber that forms a toroidal plasma which completes a secondary circuit of the transformer.

66. An apparatus for delivering dissociated gas, the apparatus comprising:
a generator for dissociating gas; and
a gas flow-control valve in gaseous communication with a gas output of the generator, the valve comprising:
a first portion defining a first aperture for fluid communication with the gas output;
a second portion defining a second aperture at least partially aligned with the first aperture, the second aperture in fluid communication with a gas delivery port; and
a movable element disposed between the first and the second portions, the moveable element defining an aperture that at least partially aligns with the first and second apertures when the moveable element is in an open position and that misaligns with at least one of the first and second apertures when the moveable element is in a closed position, the moveable element is spaced from the first and second portions to limit conductance through the valve when in the closed position without requiring a first seal between the moveable element and the first portion or a second seal between the moveable element and the second portion.

67. The apparatus of claim 66, wherein a distance between the valve and the generator is less than six inches.

68. The apparatus of claim 66, wherein the generator comprises:
a plasma chamber;
a transformer having a magnetic core surrounding a portion of the plasma chamber and a primary winding; and
an AC power supply inducing an AC potential inside the chamber that forms a toroidal plasma which completes a secondary circuit of the transformer.

69. A system comprising:
a chamber including an inlet and an outlet for a fluid;
a pump for controlling pressure in the chamber; and
a valve positioned between the outlet and the pump, the valve comprising:
a first portion defining a first aperture for fluid communication with the pump;
a second portion defining a second aperture at least partially aligned with the first aperture, the second aperture in fluid communication with the chamber; and
a movable element disposed between and spaced from the first and second portions to allow conduction of at least a substantial portion of thermal energy from the first portion to the second portion, the moveable element defining an aperture that at least partially aligns with the first and second apertures when the moveable element is in an open position and that misaligns with at least one of the first and second apertures when the moveable element is in a closed position.

70. The system of claim 69, wherein the valve operates at a temperature of about 200° C. or more.

71. The system of claim 70, wherein the valve operates at a temperature less than about 1000° C.

72. The system of claim 69, wherein heat from a heat source is transferred to the moveable element through at least one of the first portion and the second portion of the valve.

73. The system of claim 72, wherein the heat source is in thermal contact with at least one of the first portion and the second portion of the valve.

74. The system of claim 72, wherein the heat source is at least partially embedded within the first portion or the second portion.

75. The system of claim 69, wherein the fluid comprises a heated or energetic gas.

76. A system comprising:
a chamber including an inlet and an outlet for a fluid;
a pump for controlling pressure in the chamber; and
a valve positioned between the outlet and the pump, the valve comprising:
a first portion defining a first aperture for fluid communication with the pump;
a second portion defining a second aperture at least partially aligned with the first aperture, the second aperture in fluid communication with the chamber; and
a movable element disposed between and spaced from the first and second portions, the moveable element defining an aperture that at least partially aligns with the first and second apertures when the moveable element is in an open position and that misaligns with at least one of the first and second apertures when the moveable element is in a closed position, the first and second portions at least substantially shielding the moveable element from a flow of a fluid when the moveable portion is in the open position.

77. The system of claim 76, wherein the valve operates at a temperature of about 200° C. or more.

78. The system of claim 77, wherein the valve operates at a temperature less than about 1000° C.

79. The system of claim 77, wherein heat from a heat source is transferred to the moveable element through at least one of the first portion and the second portion of the valve.

80. The system of claim 79, wherein the heat source is in thermal contact with at least one of the first portion and the second portion of the valve.

81. The system of claim 79, wherein the heat source is at least partially embedded within the first portion or the second portion.

82. The system of claim 76, wherein the fluid comprises a heated or energetic gas.

83. A system comprising:
a chamber including an inlet and an outlet for a fluid;
a pump for controlling pressure in the chamber; and
a valve positioned between the outlet and the pump, the valve comprising:
a first portion defining a first aperture for fluid communication with the pump;
a second portion defining a second aperture at least partially aligned with the first aperture, the second aperture in fluid communication with the chamber; and
a movable element disposed between the first and the second portions, the moveable element defining an aperture that at least partially aligns with the first and second apertures when the moveable element is in an open position and that misaligns with at least one of the first and second apertures when the moveable element is in a closed position, the moveable element is spaced from the first and second portions to limit conductance through the valve when in the closed position without requiring a first seal between the moveable element and the first portion or a second seal between the moveable element and the second portion.

84. The system of claim 83, wherein the valve operates at a temperature of about 200° C. or more.

85. The system of claim 84, wherein the valve operates at a temperature less than about 1000° C.

86. The system of claim 83, wherein heat from a heat source is transferred to the moveable element through at least one of the first portion and the second portion of the valve.

87. The system of claim 86, wherein the heat source is in thermal contact with at least one of the first portion and the second portion of the valve.

88. The system of claim 86, wherein the heat source is at least partially embedded within the first portion or the second portion.

89. The system of claim 83, wherein the fluid comprises a heated or energetic gas.
